(19) United States
(12) Patent Application Publication
(10) Pub. No.: US 2005/0091138 A1
(43) Pub. Date: Apr. 28, 2005

(54) Method and apparatus for processing reward point, and computer product therefor

(75) Inventor: Kiyotaka Awatsu, Inagi (JP)

Correspondence Address: STAAS & HALSEY LLP, SUITE 700, 1201 NEW YORK AVENUE, N.W., WASHINGTON, DC, 20005, US

(73) Assignees: Fujitsu Limited, Kawasaki (JP); Fujitsu Frontech Limited, Tokyo (JP)

(21) Appl. No.: 10/995,248

(22) Filed: Nov. 24, 2004

Related U.S. Application Data
(63) Continuation of application No. PCT/JP02/06549, filed on Jun. 28, 2002.

(51) Int. Cl. G06F 17/60

(52) U.S. Cl. 705/35

(57) ABSTRACT

An apparatus for processing a point that is given to a customer as a reward includes an investment executing unit that executes an investment with an amount of investment calculated based on the point of the customer; and a investment returning unit that converts an amount of money obtained as a result of the investment into the point, and that returns the point converted to the customer.

### BACKGROUND OF THE INVENTION

1) Field of the Invention

The present invention relates to a technology for processing a point that is given to a customer as a reward.

2) Description of the Related Art

One of the popular methods to attract customers is so called a point service offered by a sale store. The customers can earn points corresponding to purchase of goods as a reward, and based on the points, the customers can receive a benefit such as a discount at the time of purchasing goods, or a gift certificate or a good in exchange for the points, thereby providing special services to the customers.

In stores offering this point service, a point system for managing points of respective customers associated with customer numbers of respective customers has been generally constructed. Specifically in this system, when a point is generated due to a purchase of goods by the customer, this point system adds the generated point to the points managed associated with a number designated to each customer. On the other hand, when a customer uses the points for a discount or the like at the time of purchasing goods, the used points are subtracted from the customer's points.

However, the conventional point system manages only the points given to the customers, and has a problem in that it does not sufficiently contribute to attract the customers by the point service.

In other words, it is necessary to generate points by purchase of goods, in order to increase the points managed by the point system. Therefore, when there is a large difference between the points necessary for goods, which a customer wishes to obtain by the points, and the points held by the customer, the points do not attract the customer. Accordingly, there is a problem in that simple management of the points by the point system does not sufficiently contribute to attract the customers.

Thus, in stores offering this kind of point services, it is an important object as to how to make the points held by customers (points managed by the point system) enticing to them, and not only simple management of the customers' points, but also construction of a system that can sufficiently contribute to attract the customers are required.

### SUMMARY OF THE INVENTION

It is an object of the present invention to solve at least the above problems in the conventional technology.

An apparatus for processing a point, which is given to a customer as a reward, according to one aspect of the present invention includes an investment executing unit that executes an investment with an amount of investment calculated based on the point of the customer; and an investment returning unit that converts an amount of money obtained as a result of the investment into a return point, and that returns the return point to the customer.

A method for processing a point, which is given to a customer as a reward, according to another aspect of the present invention includes executing an investment with an amount of investment calculated based on the point of the customer; converting an amount of money obtained as a result of the investment into a return point; and returning the return point to the customer.

A computer-readable recording medium according to still another aspect of the present invention stores a computer program makes a computer realize a method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a configuration of an investment system including a point investment server according to a first embodiment of the present invention;

FIG. 2 is a block diagram of a configuration of a store system shown in FIG. 1;

FIG. 3 is a table of a customer DB in a normal work server shown in FIG. 2;

FIG. 4 is a table of a customer investment DB in the point investment server shown in FIG. 2;

FIG. 5 is a table of a customer DB for a store in the point investment server shown in FIG. 2;

FIG. 6 is a flowchart of an overall processing by the store system;

FIG. 7 is a flowchart of a goods purchase processing by the store system;

FIG. 8 is a flowchart of an investment acceptance processing;

FIG. 9 is a flowchart of an investment-change acceptance processing by the store system;

FIG. 10 is a flowchart of an investment-history access processing;

FIG. 11 is a flowchart of an investment execution processing by the store system;

FIG. 12 is a flowchart of an investment return processing by the store system;

FIG. 13 is a schematic diagram of the overall processing shown in FIG. 6;

FIG. 14 is a schematic diagram of the goods purchase processing shown in FIG. 7;

FIG. 15 is a schematic diagram of the goods purchase processing shown in FIG. 7;

FIG. 16 is a schematic diagram of the investment acceptance processing shown in FIG. 8;

FIG. 17 is a schematic diagram of the investment acceptance processing shown in FIG. 8;

FIG. 18 is a schematic diagram of the investment-change acceptance processing shown in FIG. 9;

FIG. 19 is a schematic diagram of the investment-change acceptance processing shown in FIG. 9;

FIG. 20 is a schematic diagram of the investment-history access processing shown in FIG. 10;

FIG. 21 is a schematic diagram of the investment execution processing shown in FIG. 11;

FIG. 22 is a schematic diagram of the investment return processing shown in FIG. 12;

FIG. 23 is a schematic diagram of a configuration of a computer system according to a second embodiment of the present invention; and

FIG. 24 is a block diagram of a configuration of a main unit in the computer system shown in FIG. 23.

### DETAILED DESCRIPTION

Exemplary embodiments of a point processing apparatus, a point processing method, and a point processing program according to the present invention will be explained in detail with reference to the accompanying drawings.

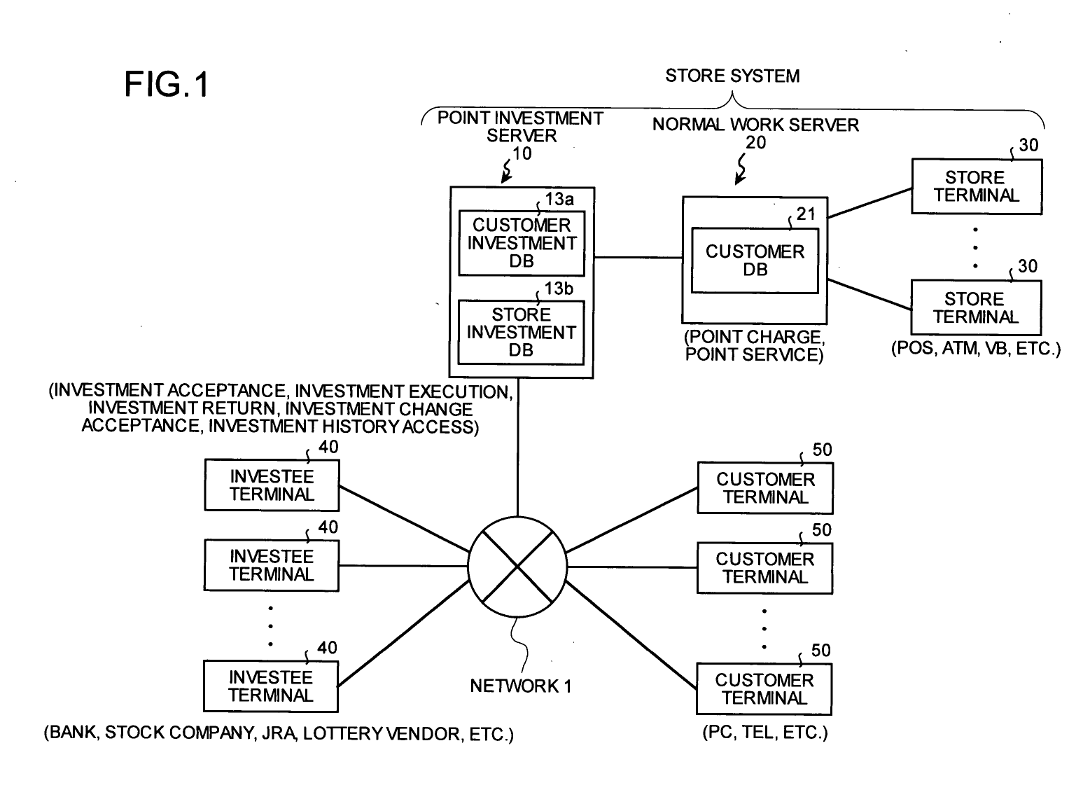

FIG. 1 is a block diagram of a configuration of an investment system including a point investment server according to a first embodiment of the present invention This investment server is formed, as shown in FIG. 1, by connecting a store system including the point investment server 10, a normal work server 20, and a plurality of store terminals 30, a plurality of investee terminals 40, and a plurality of customer terminals 50 to each other via a network 1, so as to be able to communicate with each other.

In this investment system, the normal work server 20 and the store terminals 30 included in the store system are systems for executing the point service explained in the background art. In other words, the normal work server 20 and the store terminals 30 are for giving points to customers corresponding to purchase of goods as a benefit, to provide special service to customers based on the points, such as giving a discount at the time of purchasing goods, or exchanging the points to a gift certificate or goods, for attracting the customers.

More specifically, the store terminal 30 is a terminal such as a point of sales system (POS), an automatic teller machine (ATM), or a vending machine (VB) installed in stores selling goods to customers, and schematically, receives purchase price from customers at the time of sales of goods, gives points to customers associated with the normal work server 20, and processing such as giving a discount at the time of purchase of goods is performed based on the points.

The normal work server 20 is also a server apparatus that manages points of respective customers associated with customer numbers of respective customers. Schematically, when a point is generated due to purchase of goods by a customer, the normal work server 20 adds the generated point to the points managed associated with the customer number of each customer, and on the other hand, when the points are used for a discount at the time of purchasing goods, subtracts the used points from the points of the customer.

In the store system shown in FIG. 1, the normal work server 20 and the store terminals 30 are systems for executing the point service. The point investment server 10 added to the normal work server 20 and the store terminals 30 has a main feature in that it can sufficiently contribute to attract customers by the point service.

Specifically, the point investment server 10 invests an amount of money calculated based on the customer's points managed by customer DB 21 in the normal work server 20, to execute predetermined investment (term deposit, exchange purchase, stock purchase, lottery ticket purchase, toto purchase, betting ticket purchase, or the like) by an on-line transaction with respect to the investee terminal 40, converts the amount of money obtained as a result of the executed investment to points, and returns the points to the customer. Therefore, according to the point investment server 10, the customer can increase the points, while enjoying investment without having his/her own funds. Accordingly, the main feature of the point investment server 10 such that the points of the customer are rendered an object enticing to the customer, to prompt customers to come to the store, thereby sufficiently contributing to attract customers by the point service can be realized.

The investee terminal 40 connected to the point investment server 10 via the network 1 is an information-processing equipment system managed by a predetermined investee such as a bank, a stock company, a lottery vendor, JRA, or a toto vendor, which accepts a request for predetermined investment (term deposit, exchange purchase, stock purchase, lottery ticket purchase, toto purchase, betting ticket purchase, or the like) from the point investment server 10, to perform processing for informing the point investment server 10 of the result of investment. A customer terminal 50 connected to the point investment server 10 via the network 1 is a known information processing apparatus such as a personal computer, a workstation, a PHS terminal, a portable terminal, a mobile communication terminal, or a PDA owned by a customer.

Thus, in the investment system shown in FIG. 1, the point investment server 10 exploits the main feature of sufficiently contributing to attract customers by the point service. The point investment server 10 executes processing, schematically for example, (1) investment acceptance processing, (2) investment-change acceptance processing, (3) investment-history access processing, (4) investment execution processing, and (5) investment return processing, as the processing related to the main feature. The outline and characteristics of these processing will be briefly explained below.

(1) The investment acceptance processing is processing for accepting an investment detail and investment points from a customer via the store terminal 30, and registers these in customer investment DB 13a (database storing points to be invested and the investment detail for each customer) and store investment DB 13b (database storing total amount obtained by converting the points to be invested accepted from a plurality of customers into amount of money and totaling the amounts for each investment detail).

Here, the reason why the investment detail indicating an investment type desired by a customer and investment points indicating the points to be used for the investment are accepted from the customer is for enabling execution of various kinds of investment according to the investment detail and investment points desired by the customer. Accordingly, a point investment becomes enticing to the respective customers, thereby exploiting the feature of prompting customers to come to the store.

Further, in the investment acceptance processing, the reason why the total amount obtained by converting the investment points accepted from a plurality of customers into amount of money and totaling the amounts is registered in the store investment DB 13b is for enabling execution of joint investment by the funds obtained by totaling the investment from the respective customers. Accordingly, joint investment by a plurality of customers becomes possible with respect to an investment detail that requires a large investment amount, which cannot be invested by a single customer, thereby exploiting the feature of prompting customers to come to the store. This feature is effectively exploited even when a customer holds only a small amount of points, which cannot be exchanged to a gift certificate or goods, or when the points will lapse due to the beyond-use date of the points.

(2) The investment-change acceptance processing is processing for accepting a change instruction for changing the investment detail and investment points from the customer via the store terminal 30, to update the investment detail and investment points registered in the customer investment DB 13a and the store investment DB 13b.

The reason why a change for investment contents is accepted is for enabling execution of effective investment, by studying before execution of investment whether the accepted investment is effective. Accordingly, the customer can freely increase or decrease the investment points by referring to the total investment collected in the whole store including other customers, thereby exploiting the feature of prompting customers to come to the store.

(3) The investment-history access processing is processing for accessibly outputting customers' investment histories (investment points accepted by customers, returned points returned to the customers as a result of investment, and the like) via the store terminal 30. Accordingly, since the customer can analyze the past investment results, the point investment becomes enticing to the respective customers, thereby exploiting the feature of prompting customers to come to the store.

(4) The investment execution processing is processing for requesting investment to a corresponding investee terminal 40 based on the amount of investment registered in the store investment DB 13b on the investment execution date of the respective investment details. When the customer has requested the investment, the completion of investment is notified to the customer terminal 50, and when the customer has not requested the investment on the investment execution date due to insufficient funds for investment, the customer terminal 50 is notified that the investment execution has been cancelled.

(5) The investment return processing is processing for receiving investment result (data including dividend corresponding to the investment) from the investee terminal 40, to register the points to be returned obtained by converting the dividend to the points in the store investment DB 13b, and registering the points to be returned to each customer in the customer investment DB 13a, to distribute and return the points to be returned to the respective customers who have joined the investment. When the points to be returned to the respective customers are registered in the customer investment DB 13a, a notice indicating that the points obtained as a result of investment have been returned is transmitted to the customer terminal 50 of the respective customers.

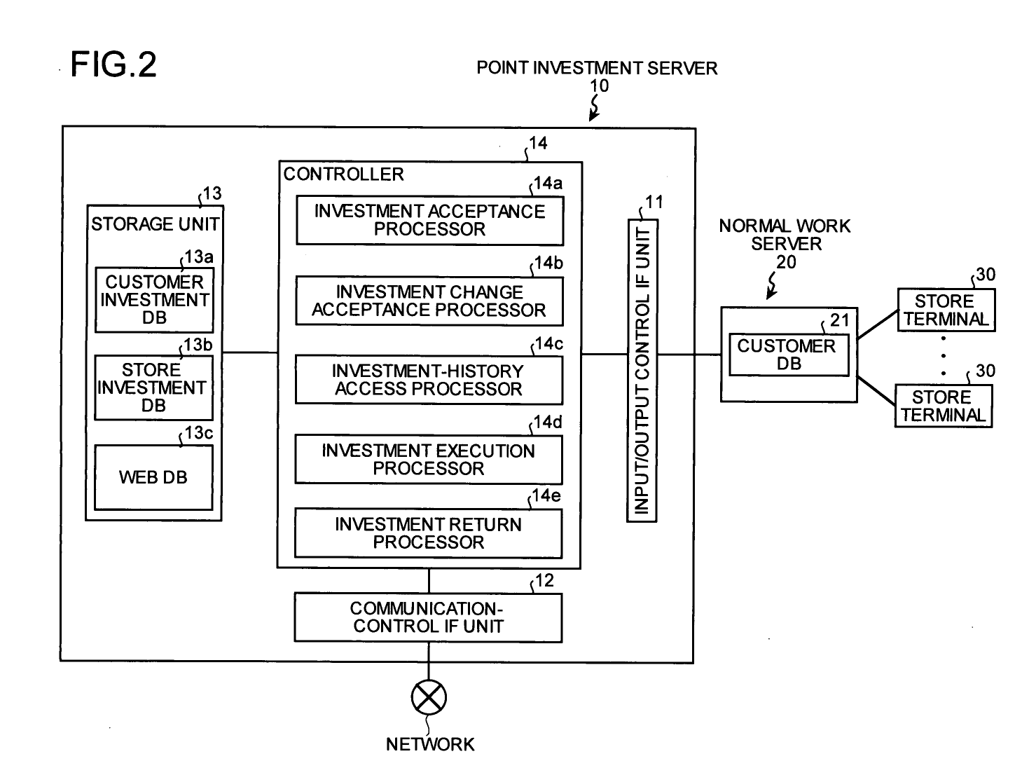

FIG. 2 is a block diagram of a configuration of the store system shown in FIG. 1. The store system is formed, as shown in FIG. 2, by connecting in series the point investment server 10, the normal work server 20, and a plurality of store terminals 30.

The normal work server 20 and the store terminals 30 are systems for executing the point service. Specifically, when points are generated by purchase of goods by a customer, the generated points are added to the points managed by the customer DB 21, associated with the customer number of each customer. When the points are used for obtaining a discount at the time of purchasing goods, the used points are subtracted from the customer's points managed by the customer DB 21. In other words, the customer executes goods purchasing processing or point using processing, via the store terminals 30, and the normal work server 20 increases or decreases the customer's points managed by the customer DB 21 corresponding to the goods purchasing processing or the point using processing.

These normal work server 20 and store terminals 30 are systems that not only execute the point service, but also cooperate with the point investment server 10 to execute the processing relating to the point investment. In other words, the point investment server 10 executes the investment acceptance processing, the investment-change acceptance processing, and the investment-history access processing for customers via the store terminals 30, and the normal work server 20 increases or decreases the customer's points managed by the customer DB 21 corresponding to the result of investment executed by the point investment server 10.

In conclusion, the store terminals 30 play a role as a user interface for customers, at the time of executing not only the point service such as goods purchasing processing and point using processing, but also the processing relating to the point investment (investment acceptance processing, investment-change acceptance processing, and investment-history access processing). Likewise, the normal work server 20 plays a role of increasing or decreasing the customer's points managed by the customer DB 21, not only at the time of executing the point service, but also corresponding to the result of point investment.

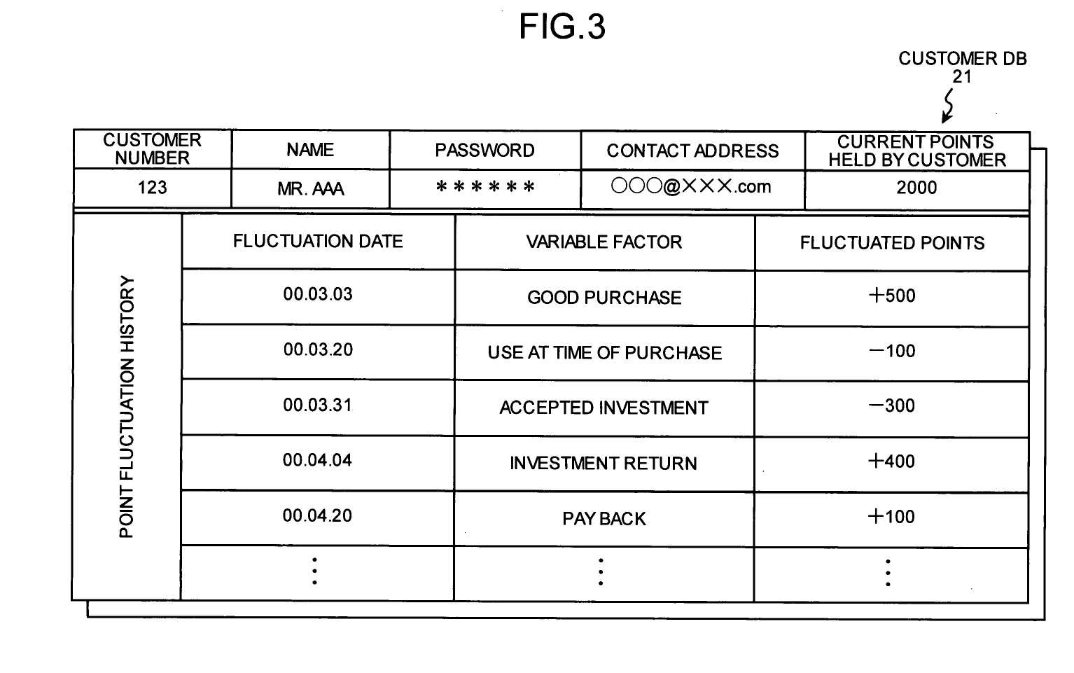

FIG. 3 is a table of the customer DB 21 in the normal work server 20 shown in FIG. 2. The customer DB 21 is database for storing the information relating to private information and points of each customer. Specifically, the information stored in the customer DB 21 is formed, as shown in FIG. 3, by associating with each other “customer number” added to each customer for uniquely identifying the customers, “name” of each customer, “password” used for membership authentication of each customer, “current points” held by each customer, and “point fluctuation history” indicating the fluctuation of points up to now.

The “point fluctuation history” is formed, as shown in FIG. 3, by associating with each other “fluctuation date” indicating the date when the fluctuation occurred in the points, “variable factor” indicating the factor of point fluctuation, and “fluctuated points” indicating the fluctuated points.

Here, the information indicating the “variable factor” includes, as shown in FIG. 3, information of “use at the time of purchase, goods purchase, accepted investment, investment return, and payback”. “Use at the time of purchase” indicates a point decrease by using the points at the time of purchasing goods, “goods purchase” indicates a point increase due to goods purchase, “accepted investment” indicates a point decrease by the investment accepted by the point investment server 10, “investment return” indicates a point increase due to return as a result of investment, and “payback” indicates a point increase when the execution of investment is cancelled due to insufficient funds for investment (when the investment points are paid back).

It is necessary for a customer to register as a member in order that the “customer number” is stored in the customer DB 21, and a membership card is provided to the customer by this membership registration. The customer inserts this membership card into the store terminal 30 for membership authentication, to receive services such as purchasing goods, using points, investment, investment change, and accessing the investment history.

Returning to FIG. 2, the point investment server 10 includes an input/output control IF unit 11, a communication-control IF unit 12, a storage unit 13, and a controller 14. The input/output control IF unit 11 is for controlling input and output of data transferred between the normal work server 20 and the point investment server 10. The communication-control IF unit 12 is for controlling the communication between the point investment server 10 and the respective investee terminals 40 or respective customer terminals 50.

The storage unit 13 is a storage unit (memory unit) for storing data and programs necessary for various kinds of processing by the controller 14, and as shown in FIG. 2, functionally and conceptually includes the customer investment DB 13a, the store investment DB 13b, and a Web DB 13c.

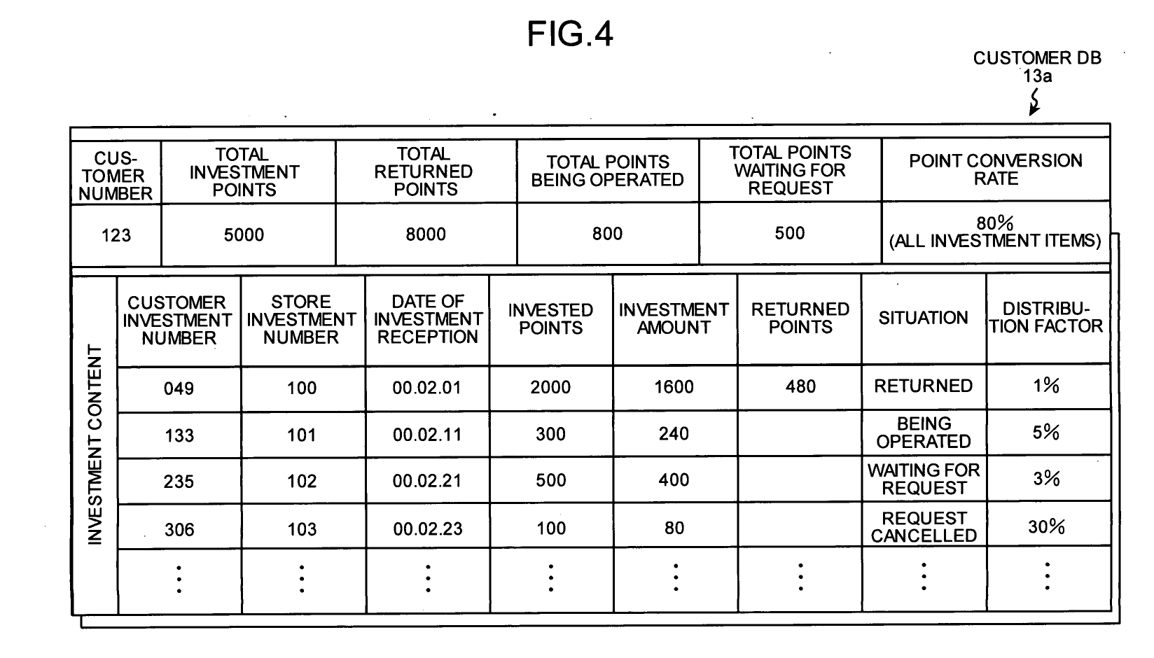

The customer investment DB 13a is database for storing information relating to the point investment for each customer. Specifically, the information stored in the customer investment DB 13a is formed, as shown in FIG. 4, by relatively associating with each other, “customer number” corresponding to the customer number stored in the customer DB 21, “total of investment points” indicating the total of points consumed for the point investment so far, “total of returned points” indicating the total of points returned to the customer as a result of point investment so far, “total points being operated” indicating the total of points, with which investment has been requested to the investee (points converted to the investment amount and being operated by the execution of investment) so far, “total points waiting for request” indicating the total of points waiting for investment request to the investee since the investment execution date has not arrived yet, “point conversion rate” indicating the conversion rate to be used when the investment-accepted points are converted to the investment amount, and “investment content” indicating the content and result of the accepted investment.

Here, the “point conversion rate” can be set to a conversion rate different from the normal conversion rate used for a discount at the time of purchasing goods, whereby the store can collect a fee for the point investment. The “point conversion rate” may be set for each customer, for example, based on the frequency the customer uses the store, volume of generated points, points used, current points, total of investment points, and returned investment total points.

The “investment content” is formed, as shown in FIG. 4, by relatively associating with each other, “customer investment number” for uniquely identifying each investment acceptance for each investment detail, “store investment number” for uniquely identifying the investment detail on the store side (corresponding to the store investment number in the store investment DB 13b described later), “date of investment reception” indicating the date when the investment is accepted from the customer, “invested points” indicating the amount of investment-accepted points, “investment amount” calculated by converting the invested points to the investment amount at the point conversion rate, “returned points” indicating the amount of points returned as a result of investment, “situation” indicating the current progressing condition for the investment content, and “distribution factor” indicating the distribution factor used at the time of distributing the points as a result of investment to the respective customers.

The information indicating the “situation” includes, as shown in the figure, “returned, being operated, waiting for request, request cancelled”. “Returned” indicates a situation in which the result of point investment has been already distributed and returned, “being operated” indicates a situation in which investment has been requested to the investee, “waiting for request” indicates a situation waiting for the investment request to the investee since the investment execution date has not arrived yet, and “request cancelled” indicates a situation in which the execution of investment has been cancelled due to an insufficient investment fund.

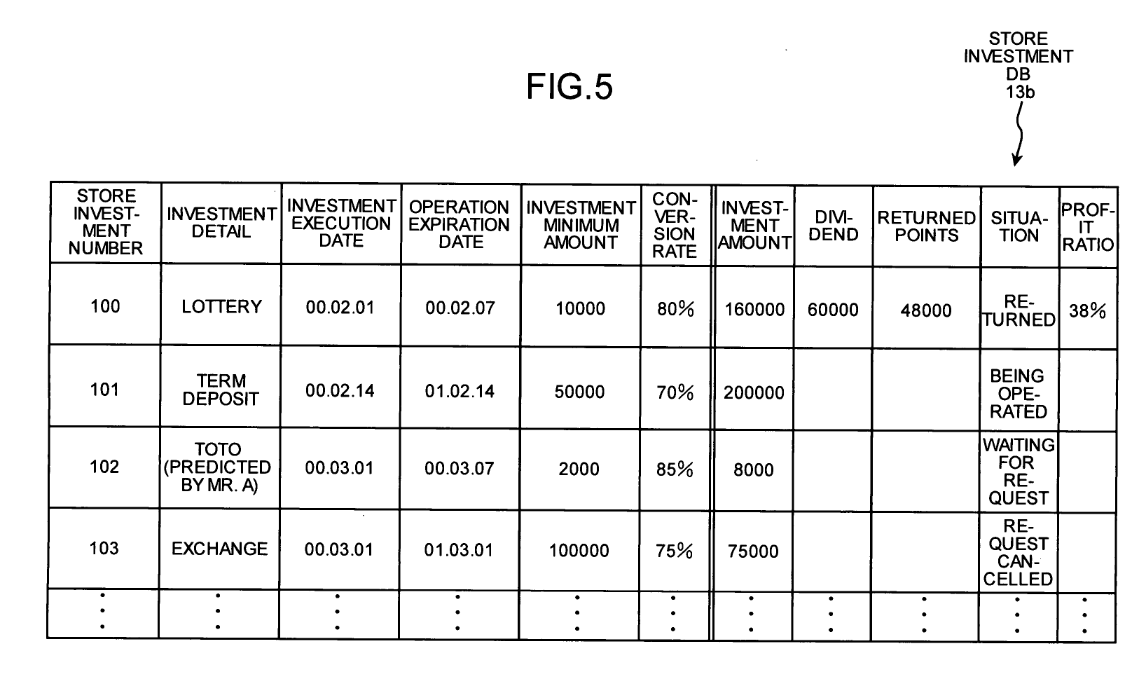

Returning to the explanation for the storage unit 13, the store investment DB 13b is database for storing information relating to the point investment for each investment detail. Specifically, the information stored in the store investment DB 13b is formed, as shown in FIG. 5, by associating with each other, “store investment number” for uniquely identifying the investment detail on the store side (corresponding to the store investment number in the store investment DB 13b), “investment detail” indicating the name of the investment detail, “investment execution date” indicating the date for requesting investment to the investee as the execution of investment, “operation expiration date” indicating the date when the operation of investment finishes to find the investment result, “investment minimum amount” indicating the minimum amount of money required for the investment, “conversion rate” used when the dividend obtained as a result of investment is converted to the points, and information such as “investment amount, dividend, returned points, situation, and profit ratio” indicating detailed contents of the investment.

The “investment minimum amount” can be set not only by the investee, but also by the store from the viewpoint of the investment strategy. The “conversion rate” is set by the store for collecting the fee for the point investment from the customers. However, after a certain amount of money is subtracted from the dividend, the normal conversion rate used for giving a discount at the time of purchasing goods may be used.

The “investment amount” indicates the amount obtained by totaling the investment amounts for a corresponding investment detail, of the investment amounts of the respective customers in the customer investment DB 13a. The “distribution factor” for each customer in the customer investment DB 13a can be determined by dividing the “investment amount” of each customer in the customer investment DB 13a by the “investment amount” in the store investment DB 13b.

The “dividend” indicates the dividend obtained as a result of investment, and the “returned points” indicate the points calculated by converting the dividend to the points at the conversion rate. The “returned points” for each customer in the customer investment DB 13a can be determined by multiplying the “returned points” in the store investment DB 13b by the “distribution factor” for each customer in the customer investment DB 13a.

The “situation” corresponds to the “situation” in the customer investment DB 13a, and indicates the current progressing condition of the investment content. The “profit ratio” is a value obtained by dividing the “dividend” by the “investment amount”, and indicates the profit ratio by the investment.

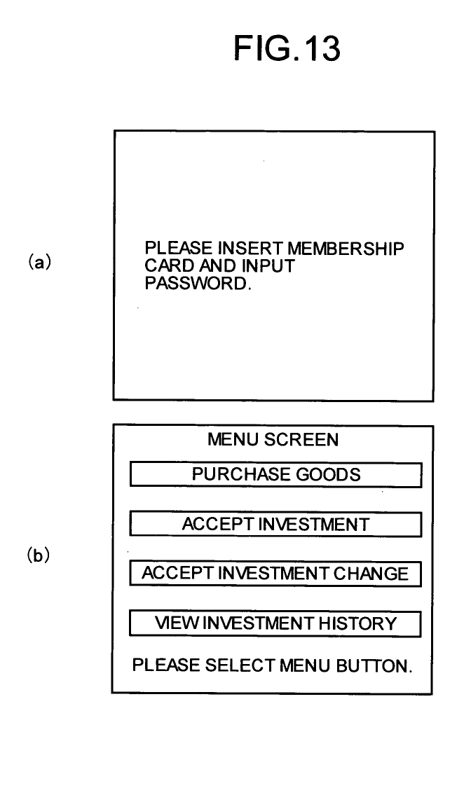

Returning to the explanation of the storage unit 13, the Web DB 13c is database for storing various kinds of Web data transmitted to the store terminal 30, the investee terminal 40, and the customer terminal 50. Specifically, the Web DB 13c stores input screen data and information screen data transmitted to the respective terminals at the time of various kinds of processing, such as purchasing goods, using points, investment acceptance processing, investment-change acceptance processing, investment-history access processing, investment execution processing, and investment return processing (see FIGS. 13 to 22).

Returning to FIG. 2, the controller 14 in the point investment server 10 is a processor having an internal memory unit that stores a control program for the operating system (OS), programs describing procedures in various kinds of processing, and necessary data, and executes various kinds of processing by the program and data. As shown in FIG. 2, the controller 14 functionally and conceptually includes an investment acceptance processor 14a, an investment change acceptance processor 14b, an investment-history access processor 14c, an investment execution processor 14d, and an investment return processor 14e.

Schematically, the investment acceptance processor 14a is a processor that accepts the investment content from a customer via the store terminal to register it in the customer investment DB 13a, and updates the store investment DB 13b and the customer DB 21 corresponding to the registered content.

The investment change acceptance processor 14b is a processor that accepts an instruction to change the investment from a customer via the store terminal, to register the investment content reflecting the investment change instruction in the customer investment DB 13a, and updates the store investment DB 13b and the customer DB 21 corresponding to the registered content.

The investment-history access processor 14c is a processor that accessibly outputs the investment histories of customers registered in the customer investment DB 13a, in response to a request from a customer via the store terminal 30.

The investment execution processor 14d is a processor that requests investment to a corresponding investee terminal 40, based on the investment amount registered in the store investment DB 13b, on the investment execution date of the respective investment details.

The investment return processor 14e is a processor that registers the returned points obtained by converting the dividend to the points in the store investment DB 13b, upon reception of the investment result (data including the dividend with respect to the investment) from the investee terminal 40, and registers each customer's returned points in the customer investment DB 13a in order to distribute and return the returned points.

Processing executed by the store system (the point investment server 10, the normal work server 20, and the store terminals 30) includes the goods purchase processing (including the processing relating to using the points at the time of purchasing goods), the investment acceptance processing, the investment-change acceptance processing, the investment-history access processing, the investment execution processing, and the investment return processing.

Among these, the investment execution processing and the investment return processing are executed by active processing by the point investment server 10. In contrast, the goods purchase processing, the investment acceptance processing, the investment-change acceptance processing, and the investment-history access processing are executed by cooperative processing between the customers and the point investment server 10 via the store terminals 30. In other words, customers select any one processing of the goods purchase processing, the investment acceptance processing, the investment-change acceptance processing, and the investment-history access processing via the store terminal 30, to execute the processing.

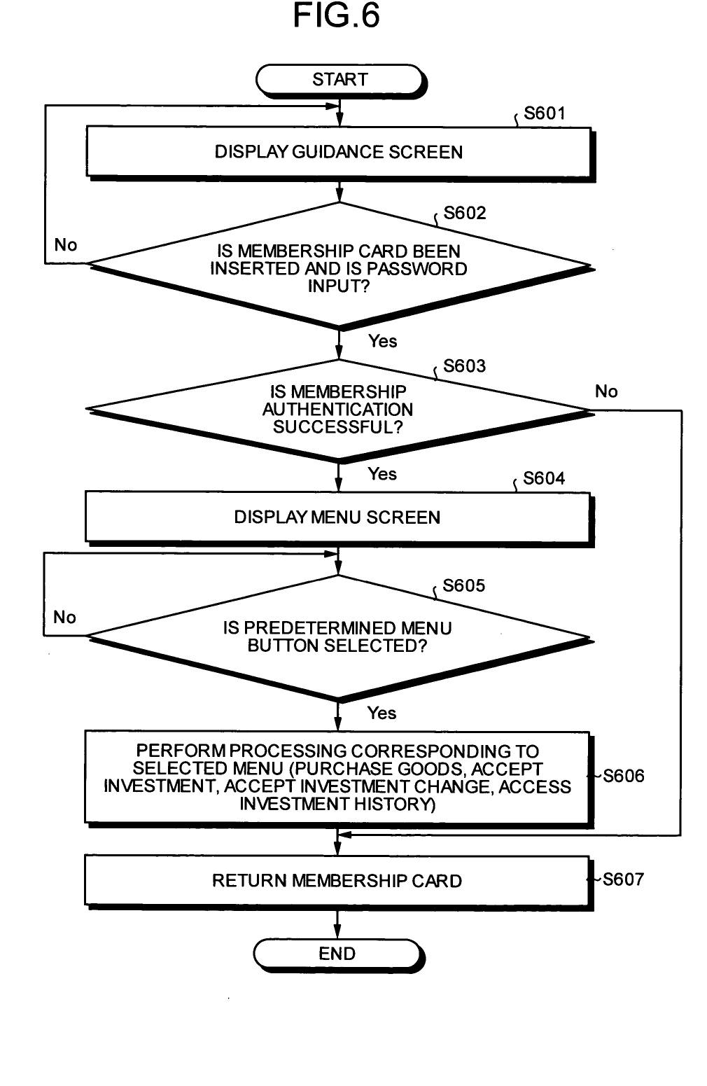

FIG. 6 is a flowchart of an overall processing by the store system. As shown in FIG. 6, in normal conditions, a guidance screen as shown in FIG. 13(a) is displayed on the store terminal 30 in the store system (step S601). Under the condition in which this guidance screen is displayed, the store terminal 30 monitors whether a membership card has been inserted into a store terminal 30 and the password has been input (step S602). When the membership card has been inserted and the password has been input (“YES” at step S602), the store terminal 30 refers to the customer DB 21 to determine whether the membership authentication has been successful (step S603).

Here, when the membership authentication has been failed (“NO” at step S603), the store terminal 30 returns the membership card and finishes the processing without executing the whole processing (step S607). On the other hand, when the membership authentication has been successful (“YES” at step S603), the store terminal 30 displays a menu screen as shown in FIG. 13(b) to the customer (step S604).

Subsequently, when the customer selects a predetermined menu button on the menu screen (“YES” at step S605), the store terminal 30 executes the processing corresponding to the selected menu button (any one of the goods purchase processing, the investment acceptance processing, the investment-change acceptance processing, and the investment-history access processing) (step S606). When the store terminal 30 finishes the processing, the store terminal 30 returns the membership card to finish the processing (step S607).

Through the series of processing, the customers can select any one of the goods purchase processing, the investment acceptance processing, the investment-change acceptance processing, and the investment-history access processing to execute the processing.

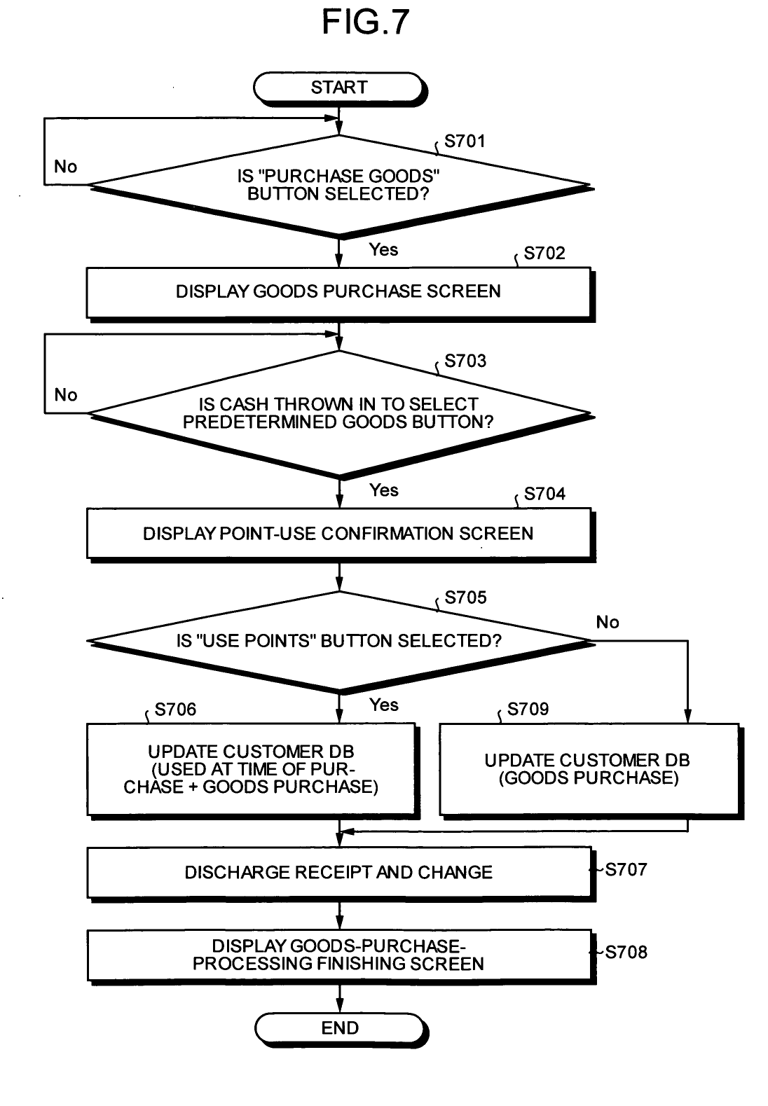

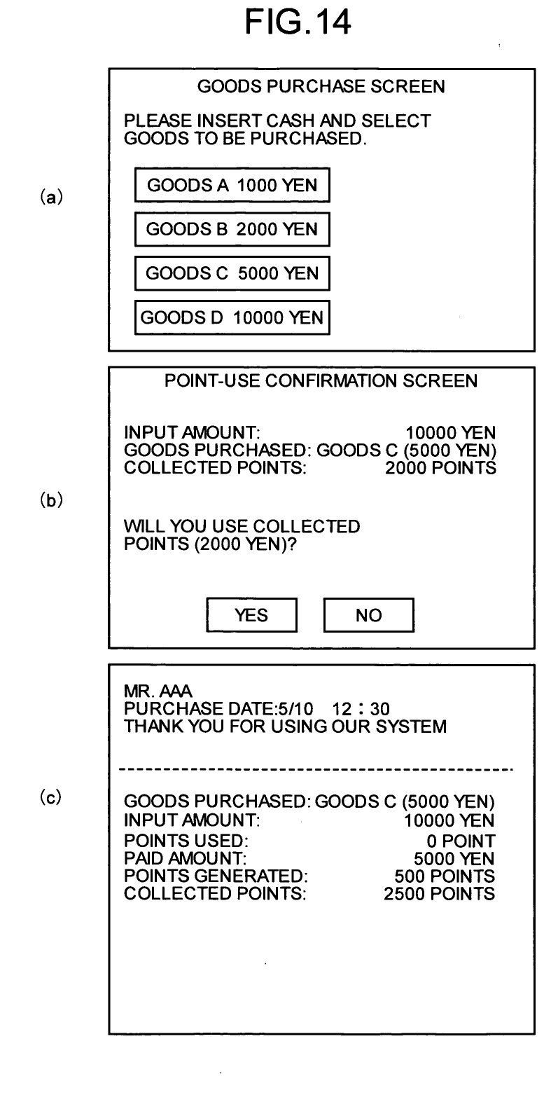

FIG. 7 is a flowchart of the goods purchase processing by the store system. As shown in FIG. 7, when a “purchase goods” button is selected on the menu screen shown in FIG. 13(b) (“YES” at step S701), the store terminal 30 displays a goods purchase screen as shown in FIG. 14(a) to the customer (step S702).

When the customer inputs cash into the store terminal to select a predetermined goods button on the goods purchase screen (YES at step S703), the store terminal 30 displays a point-use confirmation screen as shown in FIG. 14(b) to the customer (step S704). Subsequently, when the customer selects a “use points” button (“YES” button shown in FIG. 14(b)) on the point-use confirmation screen (“YES” at step S705), the normal work server 20 updates the customer DB 21 so as to reflect a point decrease corresponding to the use of points or a point increase corresponding to purchase of goods (step S706).

In the customer DB 21 shown in FIG. 3, the information relating to a point decrease corresponding to the used points (date of fluctuation, “used at the time of purchase” as a variable factor, and subtracted points as the fluctuated points), and information relating to a point increase corresponding to purchase of goods (date of fluctuation, “goods purchase” as a variable factor, and added points as the fluctuated points) are registered, as the point fluctuation history, and the value of the “current points” is updated based on these fluctuated points.

In contrast, when the customer does not select the “use point” button (“YES” button shown in FIG. 14(b)) on the point-use confirmation screen (“NO” at step S705), the normal work server 20 updates the customer DB 21 so as to reflect the point increase corresponding to the purchase of goods (step S709). In other words, in this case, in the customer DB 21 shown in FIG. 3, the normal work server 20 registers only the information relating to the point increase corresponding to the purchase of goods (date of fluctuation, “goods purchase” as a variable factor, and added points as the fluctuated points) as the point fluctuation history, and updates the value of the “current points” based on the fluctuated points.

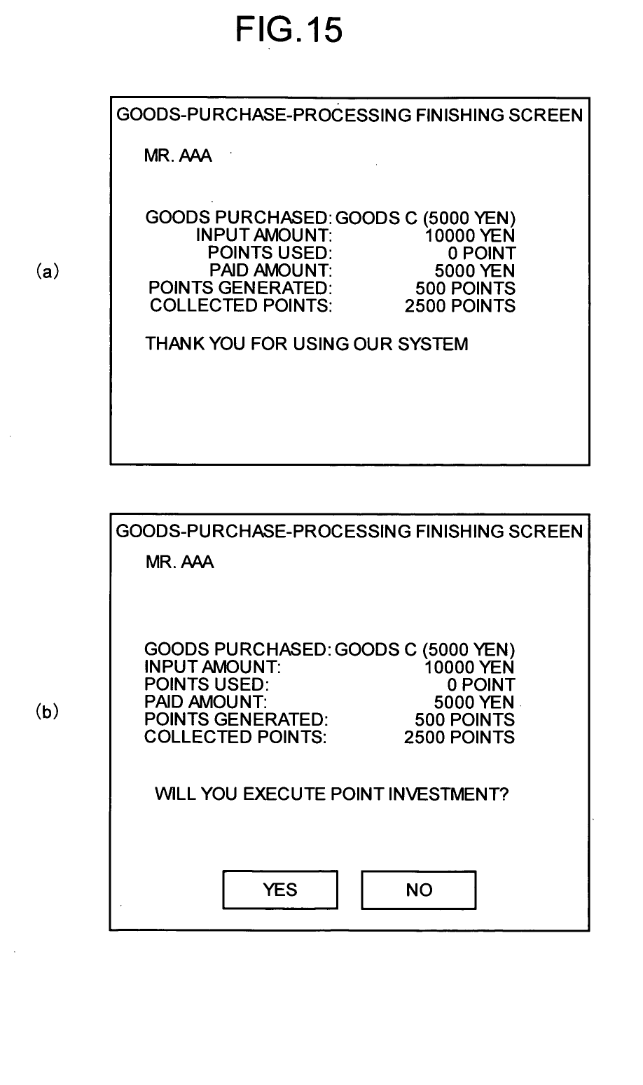

After the update processing of the customer DB 21 by the normal work server 20 (step S706 or S709), the store terminal 30 discharges a change together with a receipt as shown in FIG. 14(c), and displays a goods-purchase-processing finishing screen as shown in FIG. 15(a) to the customer, to finish the processing (step S708).

Through the series of processing, the customer can increase or decrease the points registered in the customer DB 21. Here, an example in which a goods-purchase-processing finishing screen as shown in FIG. 15(a) is displayed to the customer to finish the processing has been explained. However, subsequent to the goods purchase processing, a goods-purchase-processing finishing screen as shown in FIG. 15(b) may be displayed to the customer so that the customer can proceed to the point investment acceptance processing. That is, in this case, by selecting “YES” button on the goods-purchase-processing finishing screen, the customer can execute the investment acceptance processing, without going through the membership authentication again.

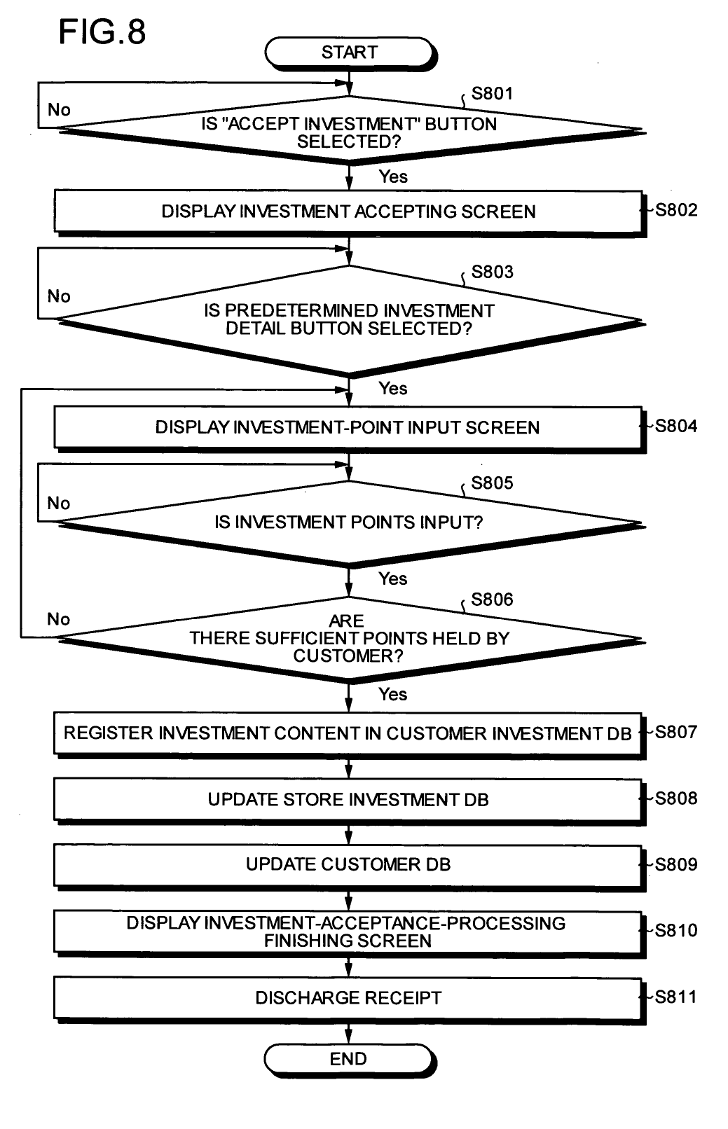

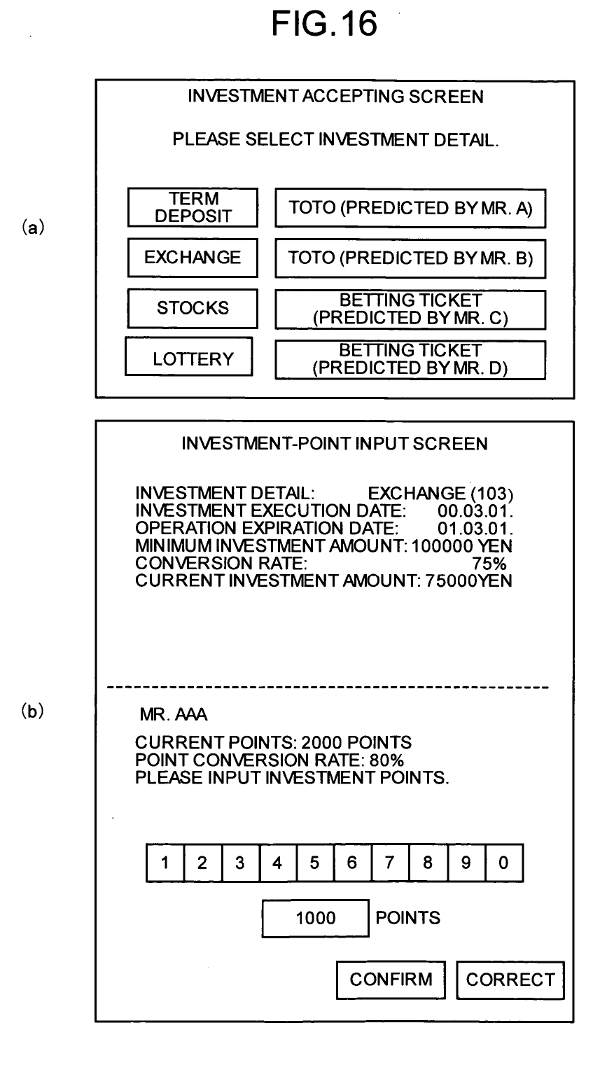

The procedure in the investment acceptance processing by the store system will be explained. FIG. 8 is a flowchart of the investment-change acceptance processing by the store system. As shown in FIG. 8, when a customer selects an “accept investment” button on the menu screen shown in FIG. 13(b) (“YES” at step S801), the investment acceptance processor 14a in the point investment server 10 displays an investment accepting screen shown in FIG. 16(a) to the customer via the store terminal 30 (step S802).

Here, the respective investment details displayed on the investment accepting screen are those, of the investment details registered in the store investment DB 13b, in which the investment execution date has not arrived yet, that is, “waiting for request” is registered as the “situation” information. Further, as for the investment detail in which a specific investment target can be optionally selected, such as toto and betting tickets, of the respective investment details displayed on the investment accepting screen, the specific investment target preselected by an anticipator is accepted from the customer. This is for collecting the investment funds of the respective customers collectively, so that joint investment can be easily executed.

Returning to FIG. 8, when the customer selects an investment detail button on the investment accepting screen (“YES” at step S803), the investment acceptance processor 14a displays an investment-point input screen as shown in FIG. 16(b) to the customer (step S804). On the investment-point input screen, not only the information such as the investment execution date, the operation expiration date, the investment minimum amount, the conversion rate, and the current investment amount for the investment detail selected by the customer, but also the information such as the current points held by the customer and the point conversion rate are displayed. Therefore, the customer can study the investment, taking the information into consideration.

When the customer inputs the investment points on the investment-point input screen (“YES” at step S805), the investment acceptance processor 14a determines whether the points held by the customer are sufficient for the input points (step S806), and when the points held by the customer are not sufficient (“NO” at step S806), displays again the investment-point input screen to the customer so as to prompt the customer to re-input the investment points (step S804).

On the contrary, when the points held by the customer are sufficient for the input points (“YES” at step S806), the investment acceptance processor 14a registers the investment content accepted from the customer in the customer investment DB 13a (step S807). In other words, each information of “customer investment number, store investment number, investment accepted date, investment points, investment amount, situation (waiting for request), and distribution factor” is registered as the investment contents in the customer investment DB 13a shown in FIG. 4, and the value of the “total points waiting for request” is updated. The “distribution factor” sequentially changes and is updated and registered, according to the acceptance of investment from other customers.

Subsequently, the investment acceptance processor 14a updates the store investment DB 13b and the customer DB 21 corresponding to the registered contents in the customer investment DB 13a (steps S808 and S809). In other words, in the store investment DB 13b shown in FIG. 5, the “investment amount” for the corresponding investment detail is updated to the amount obtained by adding the investment amount registered in the customer investment DB 13a, the information relating to a point decrease corresponding to the accepted investment (date of fluctuation, “accepted investment” as a variable factor, and subtracted points as the fluctuated points) is registered in the customer DB 21 shown in FIG. 3, and the value of the “current points” is updated based on the fluctuated points.

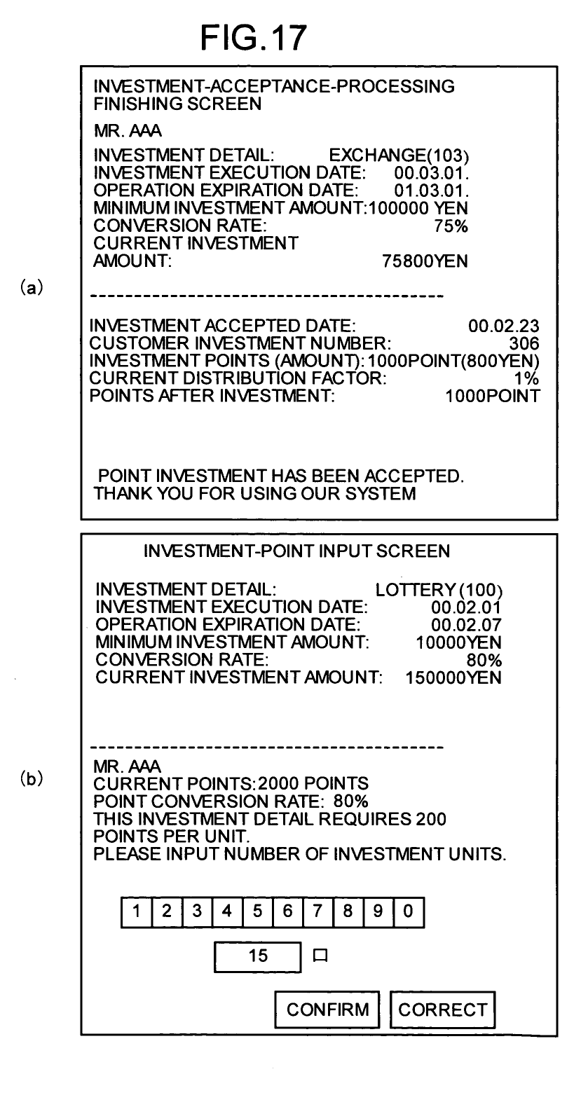

After the update processing of the customer DB 21 (step S809), the investment acceptance processor 14a displays an investment-acceptance-processing finishing screen as shown in FIG. 17(a) to the customer via the store terminal 30 (step S810), and issues a receipt including the same content as that on the investment-acceptance-processing finishing screen, to finish the processing (step S811).

Through the series of processing, the investment content accepted from the customer is registered in the customer investment DB 13a and the store investment DB 13b, and the customers' points registered in the customer DB 21 decreases corresponding to the investment points. Here, an example in which the investment-point input screen as shown in FIG. 16(b) is displayed to the customer, so as to prompt the customer to input the amount of the investment points has been explained, but an investment-point input screen as shown in FIG. 17(b) may be displayed to the customer, so as to prompt the customer to input the investment points as the number of investment units. In other words, in this case, as shown in FIG. 17(b), the number of points per unit is displayed on the investment-point input screen.

In the investment acceptance processing, an example in which the respective DB is updated in order of the customer investment DB 13a, the store investment DB 13b, and the customer DB 21 has been explained, but the DB may be updated in a different order, or the DB may be collectively updated in parallel, regardless of the order.

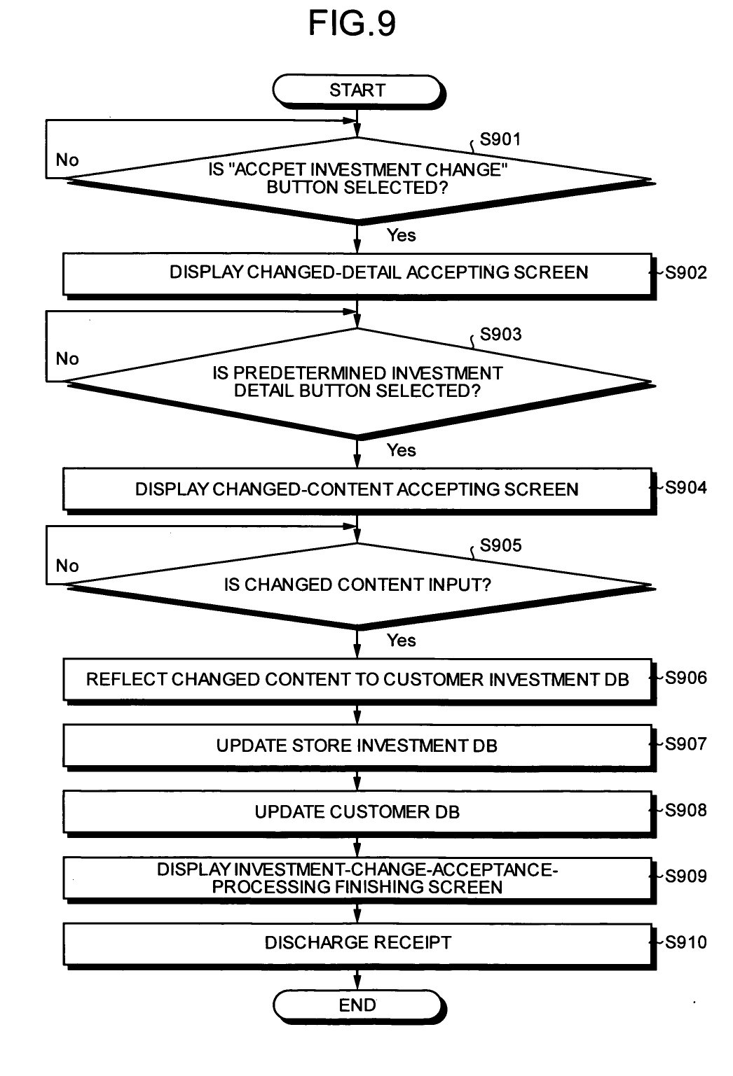

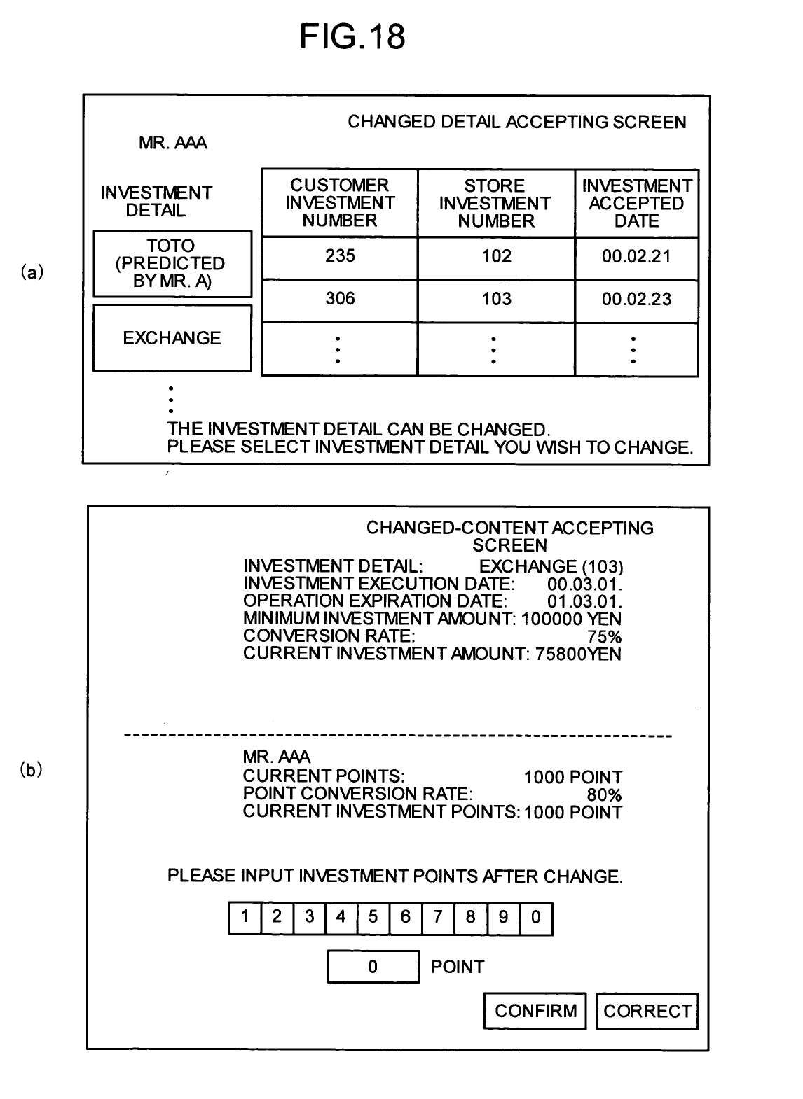

FIG. 9 is a flowchart of the investment-change acceptance processing by the store system. When the customer selects an “accept investment change” button on the menu screen shown in FIG. 13(b) (“YES” at step S901), the investment change acceptance processor 14b in the point investment server 10 displays a changed-detail accepting screen as shown in FIG. 18(a) to the customer via the store terminal 30 (step S902). The respective investment details displayed on this changed-detail accepting screen are investment details in which the investment execution date has not arrived yet, that is, “waiting for request” is registered as the “situation” information, of the investment details registered in the customer investment DB 13a.

Subsequently, when the customer selects an investment detail button on the changed-detail accepting screen (“YES” at step S903), the investment change acceptance processor 14b displays a changed-content accepting screen as shown in FIG. 18(b) to the customer via the store terminal 30 (step S904). On the changed-content accepting screen, not only the information such as the investment execution date, the operation expiration date, the investment minimum amount, the conversion rate, and the current investment amount, but also the information such as the current points held by the customer, the point conversion rate, and the current investment amount are displayed for the investment detail selected by the customer. Therefore, the customer can restudy the investment, taking the information into consideration. Particularly, it is effective to study whether the accepted own investment is effective that the collected state of the investment for the whole store including other customers can be referred.

Returning to FIG. 9, when the customer inputs the changed content (investment points after the change) on the changed-content accepting screen (“YES” at step S905), the investment change acceptance processor 14b reflects the changed content accepted from the customer in the customer investment DB 13a (step S906). In other words, in the customer investment DB 13a shown in FIG. 4, the information such as “investment accepted date, investment points, investment amount, and distribution factor” is updated corresponding to the changed content, associated with the corresponding “customer investment number and store investment number” already registered as the investment contents, and the value of the “total points waiting for request” is also updated.

Subsequently, the investment change acceptance processor 14b updates the store investment DB 13b and the customer DB 21, corresponding to the updated content of the customer investment DB 13a (steps S907 and S908). In other words, in the store investment DB 13b shown in FIG. 5, the “investment amount” for the corresponding investment detail is updated to the one reflecting the updated investment amount registered in the customer investment DB 13a, and in the customer DB 21 shown in FIG. 3, the information relating to the point increase or decrease corresponding to the accepted investment change (fluctuation date, “investment change” as a variable factor, and a difference between the already invested points and the changed investment points as the fluctuated points) is registered as the point fluctuation history, and the value of the “current points” is updated based on the fluctuated points.

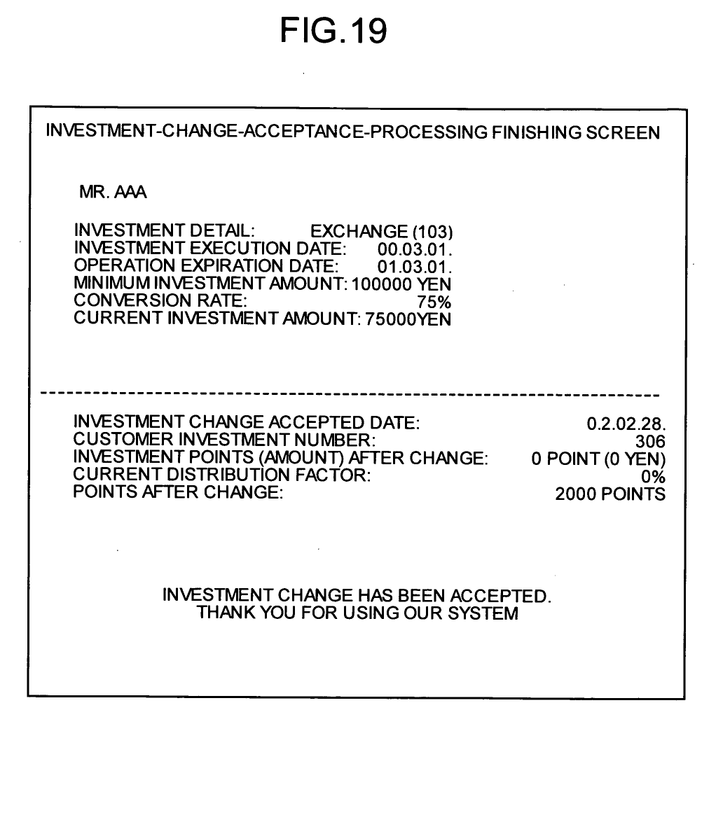

The investment change acceptance processor 14b displays an investment-change acceptance processing finishing screen as shown in FIG. 19 to the customer (step S909) via the store terminal 30, after the update processing of the customer DB 21 (step S908), and issues a receipt including the same content as that on the investment-change acceptance processing finishing screen, to finish the processing (step S910).

Through the series of processing, the changed investment content accepted from the customer is registered in the customer investment DB 13a and the store investment DB 13b, and the points of the customer registered in the customer DB 21 also increases or decreases corresponding to the changed investment content. Here, an example in which the amount of the changed investment points is input by the customer has been explained, but as in the investment acceptance processing, the investment points after the change may be input as the number of investment units. Further, an example in which the respective DB is updated in order of the customer investment DB 13a, the store investment DB 13b, and the customer DB 21 has been explained herein, but the DB may be updated in a different order, as in the investment acceptance processing, or the DB may be collectively updated in parallel, regardless of the order.

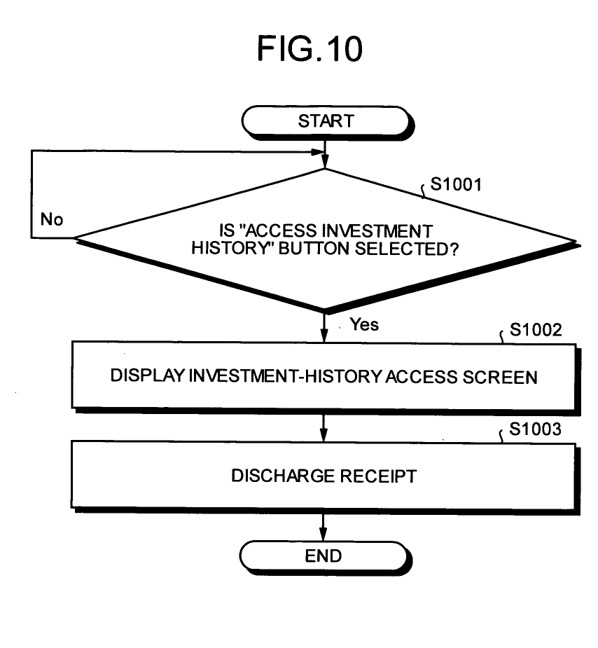

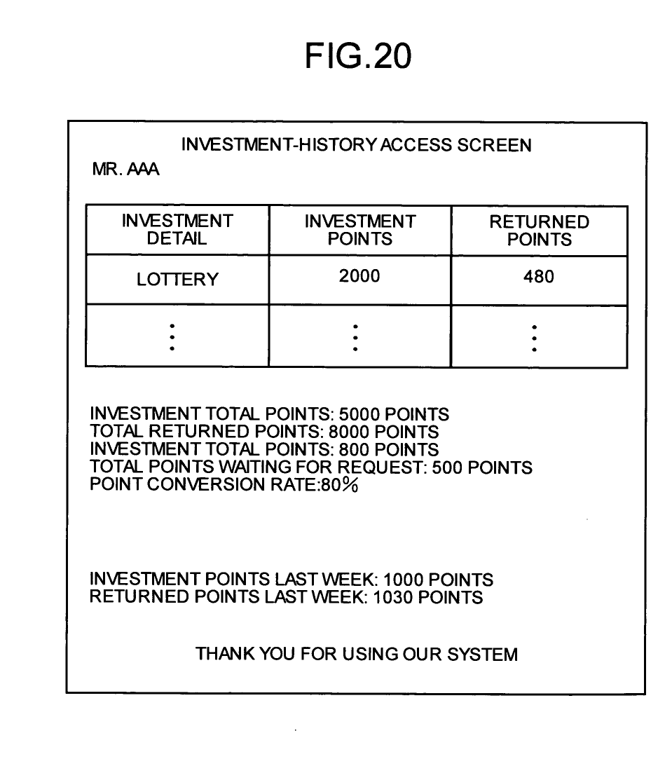

FIG. 10 is a flowchart of the investment-history access processing by the store system. When the customer selects an “Access to investment history” on the menu screen shown in FIG. 13(b) (“YES” at step S1001), the investment-history access processor 14c in the point investment server 10 displays an investment-history access screen as shown in FIG. 20 to the customer via the store terminal 30 (step S1002), and issues a receipt including the same content as that on the investment-history access screen, to finish the processing (step S1003).

On the investment-history access screen, as shown in the figure, the “investment points” and the “returned points” of the customer are displayed for each information detail, for which the points have been already returned to the customer, as well as the cumulative information such as “investment total points, the total of returned points, the total points being operated, total points waiting for request, and point conversion rate” registered in the customer investment DB 13a, and the recent spot information such as “investment points in the last week, and the returned points in the last week”. Therefore, the customer can analyze the past information results by referring to the investment-history access screen.

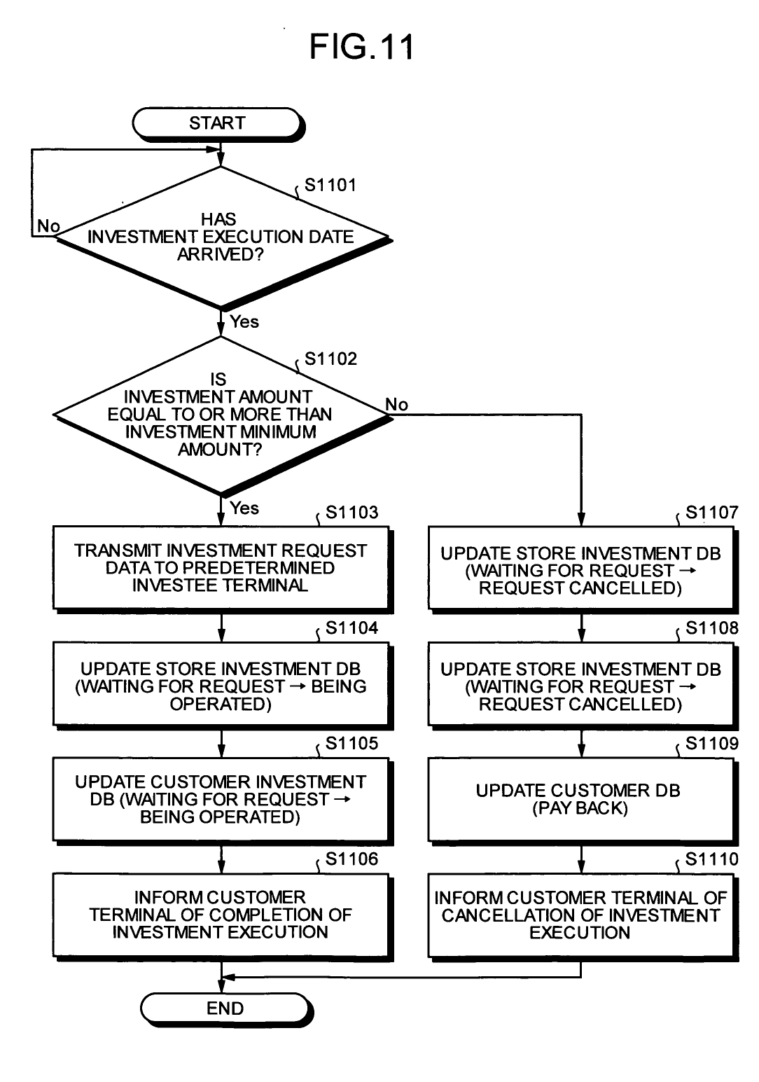

FIG. 11 is a flowchart of the investment execution processing by the store system. The investment execution processor 14d in the point investment server 10 continuously determines whether the investment execution date has arrived, for the investment details registered in the store investment DB 13b, in which “waiting for request” has been registered as the “situation” information (step S1101).

When there is the investment detail for which the investment execution date has arrived (“YES” at step S1101), the investment execution processor 14d determines whether the current investment amount is equal to or more than the investment minimum amount (step S1102), and when the current investment amount is equal to or more than the investment minimum amount (“YES” at step S1102), as shown at steps S1103 to S1106, the investment execution processor 14d performs processing relating to the execution of investment. However, when the current investment amount does not exceed the investment minimum amount (“NO” at step S1102), as shown at steps S1107 to S1110, the investment execution processor 14d performs processing relating to cancellation of investment execution.

In other words, when the current investment amount is equal to or more than the investment minimum amount (“YES” at step S1102), the investment execution processor 14d transmits the investment request data (data including information specifying the investment detail and information indicating the investment amount) to the investee terminal 40 corresponding to the investment detail (step S1103).

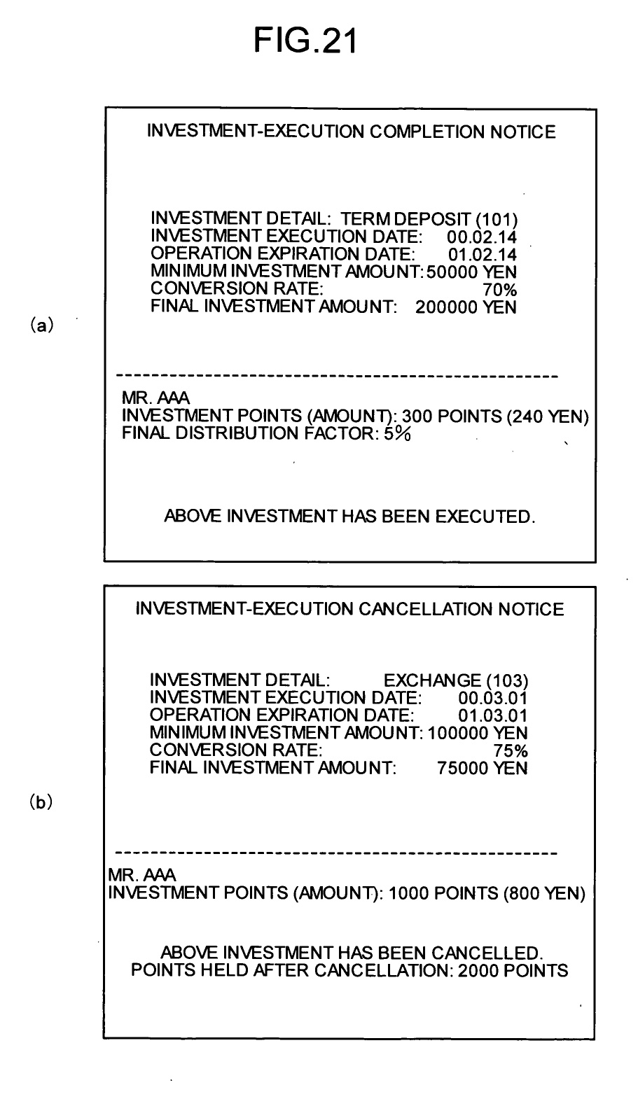

Subsequently, the investment execution processor 14d updates the “situation” information for the corresponding investment detail from “waiting for request” to “being operated” in the store investment DB 13b shown in FIG. 5 (step S1104). The investment execution processor 14d also updates the “situation” information for the corresponding investment detail of each customer from “waiting for request” to “being operated” in the customer investment DB 13a shown in FIG. 4, and updates the values of the “total points being operated” and the “total points waiting for request” (step S1105). The investment execution processor 14d transmits an investment execution completion notice as shown in FIG. 21(a) to the customer terminal 50 of the customer whose investment has been accepted, to finish the processing (step S1106).

On the contrary, when the current investment amount is not equal to or more than the investment minimum amount (“NO” at step S1102), the investment execution processor 14d updates the “situation” information for the corresponding investment detail of each customer from “waiting for request” to “request cancelled” in the store investment DB 13b shown in FIG. 5 (step S1107). Further, the investment execution processor 14d updates the “situation” information for the corresponding investment detail of each customer from “waiting for request” to “request cancelled” in the customer investment DB 13a shown in FIG. 4, and updates the value of the “total points waiting for request” (step S1108).

The investment execution processor 14d registers the information relating to a point increase corresponding to the cancellation of investment execution (fluctuation date, “payback” as a variable factor, and increased points as the fluctuated points) as the point fluctuation history of the customer whose investment has been accepted in the customer DB 21 shown in FIG. 3, and updates the value of the “current points” based on the fluctuated points (step S1109). The investment execution processor 14d transmits an investment execution cancellation notice as shown in FIG. 21(b) to the customer terminal 50 of the customer whose investment has been accepted, to finish the processing (step S1110).

Through the series of processing, investment is executed with respect to the corresponding investee for the investment detail, for which the investment amount is sufficient on the investment execution date, and on the other hand, the investment request is not issued to the corresponding investee for the investment detail, for which the investment amount is not sufficient on the investment execution date, and the investment points accepted from the customer are paid back.

In the investment execution processing, an example in which the respective DB is updated in order of the store investment DB 13b, the customer investment DB 13a, and the customer DB 21 has been explained herein, but the DB may be updated in a different order, or the DB may be collectively updated in parallel, regardless of the order.

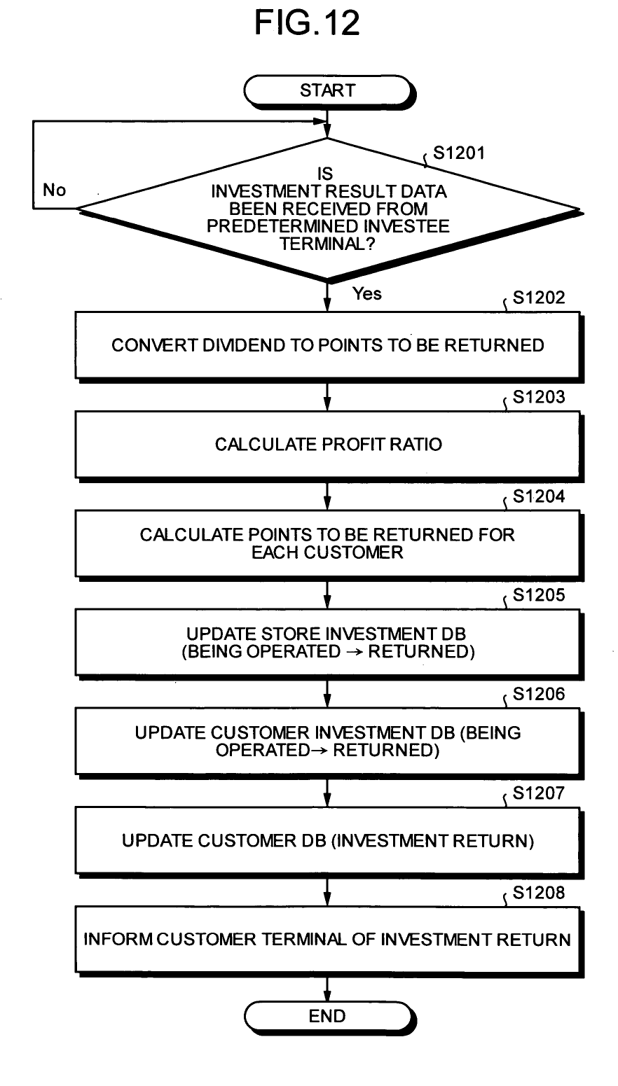

FIG. 12 is a flowchart of the investment return processing by the store system. Upon reception of the investment result data (data including the information specifying the investment detail and the information indicating the dividend) from a predetermined investee terminal 40 (step S1201), the investment return processor 14e in the point investment server 10 refers to the “conversion rate” for the corresponding investment detail registered in the store investment DB 13b, to convert the dividend to the points to be returned (step S1202).

Subsequently, the investment return processor 14e calculates the profit ratio from the dividend by using the “investment amount” for the corresponding information detail registered in the store investment DB 13b (step S1203), and calculates points to be returned to each customer by using the “distribution factor” for the corresponding information detail registered in the customer investment DB 13a (step S1204).

The investment return processor 14e then updates the “situation” information for the corresponding investment detail from “being operated” to “returned” and registers respective “dividend, returned points, and profit ratio” in the store investment DB 13b shown in FIG. 5 (step S1205). Further, the investment return processor 14e updates the “situation” information for the corresponding investment detail from “being operated” to “returned”, registers the “returned points”, and updates the value of “total of returned points and investment total points” in the customer investment DB 13a shown in FIG. 4 (step S1206).

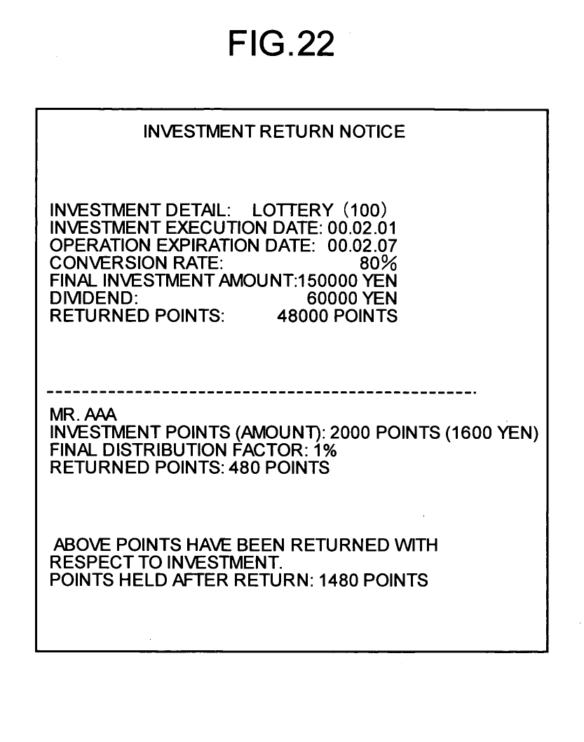

The investment return processor 14e further registers the information relating to a point increase due to the return as a result of investment (date of fluctuation, “investment return” as the variable factor, and added points as the fluctuated points) in the customer DB 21 shown in FIG. 3, as the point fluctuation history of the customer to whom the result of investment has been returned, and updates the value of the “current points” based on the fluctuated points (step S1207). The investment return processor 14e transmits an investment return notice as shown in FIG. 22 to the customer terminal 50 of the customer to whom the result of investment has been returned, to finish the processing (step S1208).

Through the series of processing, the customer's points registered in the customer DB 21 increases corresponding to the result of point investment. In the investment return processing, an example in which the respective numerical values are determined according to the order of conversion of the returned points, calculation of profit ratio, and calculation of returned points to each customer has been explained, but the respective numerical values may be determined in a different order, or may be collectively determined in parallel. Further, an example in which the respective DB is updated in order of the store investment DB 13b, the customer investment DB 13a, and the customer DB 21 has been explained, but the DB may be updated in a different order, as in the investment execution processing, or the DB may be collectively updated in parallel, regardless of the order.

In the first embodiment, the point investment server 10 invests an amount of money calculated based on the customer's points managed by customer DB 21 in the normal work server 20, to execute predetermined investment (term deposit, exchange purchase, stock purchase, lottery ticket purchase, toto purchase, betting ticket purchase, or the like) by the on-line transaction with respect to the investee terminal 40, converts the amount of money obtained as a result of the executed investment to points, and returns the points to the customer. Therefore, the customer can increase the points as a result of investment, while enjoying investment without having his/her own funds. Accordingly, the points held by the customer are rendered an object enticing to the customer, to prompt customers to come to the store, thereby sufficiently contributing to attract customers by the point service.

The point investment server 10 explained in the first embodiment can be realized by executing a preset program by a computer system such as a personal computer or a workstation.

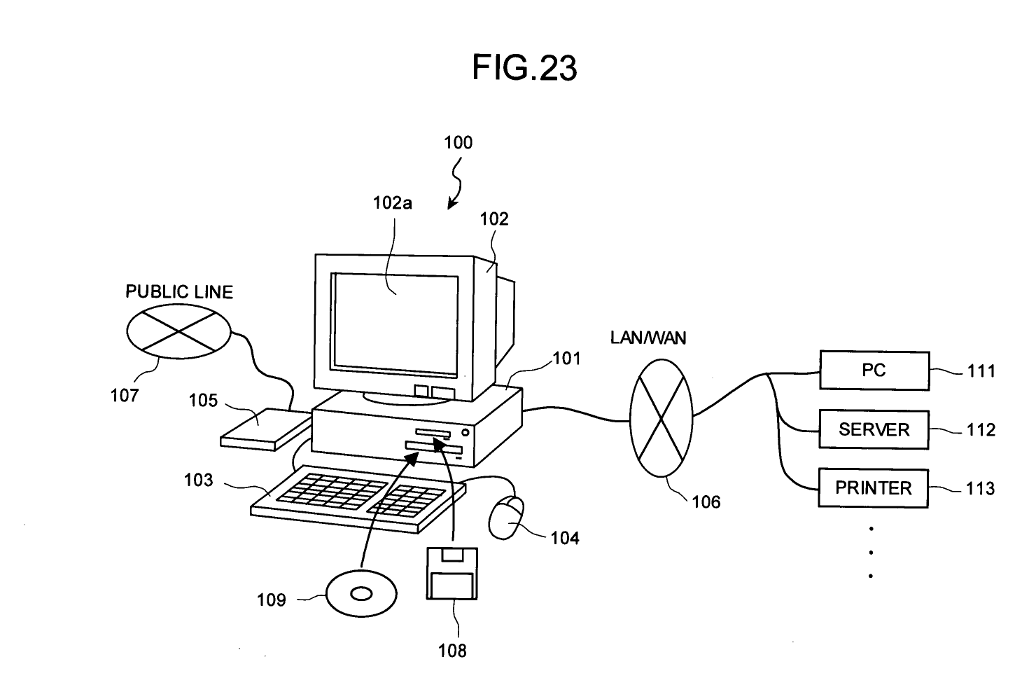

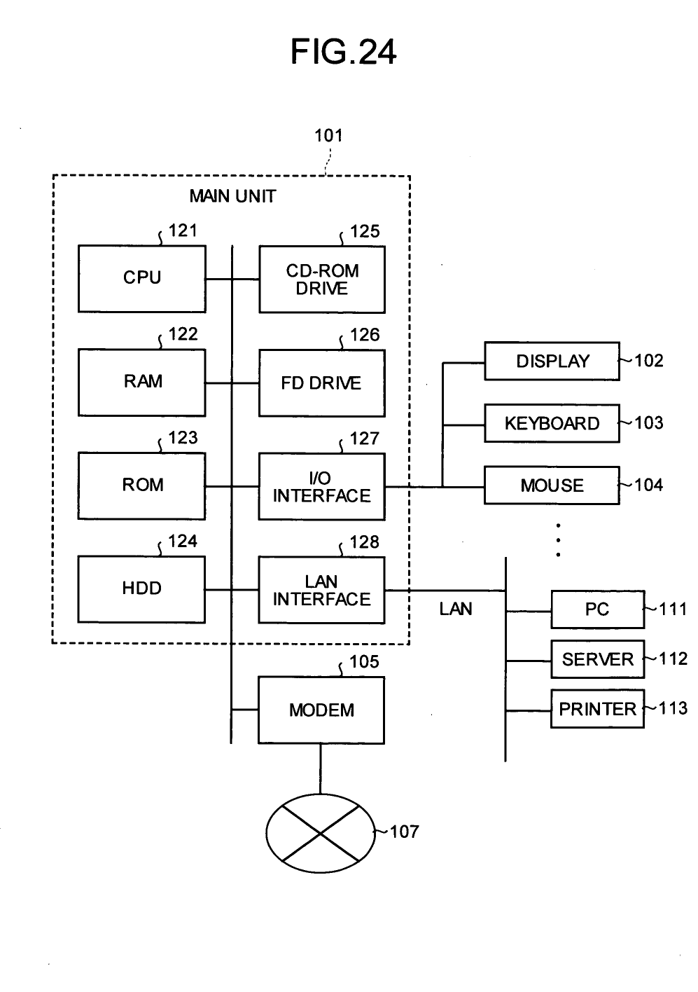

FIG. 23 is a schematic diagram of a configuration of a computer system according to a second embodiment of the present invention. FIG. 24 is a block diagram of a configuration of a main unit in the computer system shown in FIG. 23. As shown in FIG. 23, the computer system 100 according to the second embodiment includes a main unit 101, a display 102 for displaying the information such as images on a display screen 102a according to an instruction from the main unit 101, a keyboard 103 for inputting various kinds of information to the computer system 100, and a mouse 104 for specifying an optional position on the display screen 102a of the display 102.

The main unit 101 in the computer system 100 includes, as shown in FIG. 24, a CPU 121, a RAM 122, a ROM 123, a hard disk drive (HDD) 124, a CD-ROM drive for receiving a CD-ROM 109, a flexible disk (FD) drive 126 for receiving an FD 108, an I/O interface 127 for connecting the display 102, the keyboard 103, and the mouse 104, and a LAN interface 128 for the connection to a local area network or a wide area network (LAN/WAN) 106.

A modem 105 for connecting the computer system 100 to a public line such as the Internet is connected to the computer system 100, and further, other computer systems (PC) 111, a server 112, and a printer 113 are connected thereto via the LAN interface 128 and the LAN/WAN 106.

The computer system 100 realizes the point investment server 10 by reading and executing the point investment program recorded on a predetermined recording medium.

Here, the predetermined recording medium includes all types of recording media that record a password input program readable by the computer system 100, for example, a “portable physical medium” such as the FD 108, the CD-ROM 109, an MO disk, a DVD disk, a magneto-optical disk, an IC card, a “fixed physical medium” such as the HDD 124, the RAM 122, and the ROM 123 equipped inside and outside of the computer system 100, and a “communication medium” that holds the program for a short term at the time of transmission of the program such as a public line 107 connected via the modem 105 and the LAN/WAN 106 to which other computer systems 111 and the server 112 are connected.

In other words, the password input program is computer-readably recorded on the recording media such as the “portable physical medium”, the “fixed physical medium”, and the “communication medium”, and the computer system 100 reads and executes the password input program from such a recording medium, to realize a password input apparatus (password input method). The password input program is not limited to the one executed by the computer system 100, but the present invention is also applicable when the other computer system 111 or the server 112 executes the point investment program, or when these cooperate to execute the point investment program.

While exemplary embodiments of the present invention have been explained above, various embodiments other than the above ones may be made possible without departing from the technical spirit of the appended claims.

For example, in the above embodiments, an example in which the investment acceptance processing, the investment-change acceptance processing, and the investment-history access processing are executed between customers and the store via the store terminal 30 has been explained. However, the present invention is not limited thereto, and is also applicable when these processing is executed between customers and the store via the customer terminal 50. Thus, it is effective to prompt the customers to execute the point investment that these processing can be executed from not only the store terminal 30, but also from the customer terminal 50.

In the embodiments, an example in which as the investment execution processing and the investment return processing, an investment execution completion notice and an investment return notice are transmitted to the customer terminal 50 has been explained, but the present invention is not limited thereto. The present invention is also applicable when these notices are output accessibly by the store terminal 30, without transmitting these notices to the customer terminal 50. Thus, it is effective to prompt the customer to come to the store that the investment result can be obtained only by the store terminal 30.

In the embodiments, an example in which a system including the point investment server 10, the normal work server 20, and a plurality of store terminals 30 has been explained as one store system, but the present invention is not limited thereto. For example, the present invention is applicable when point investments by customers in a plurality of stores are processed by connecting the normal work server 20 and the store terminals 30 respectively installed in the respective stores to one point investment server 10 via the network 1. In this case, point investment can be promoted under the element of competition between stores, by executing the investment by each store.

In the embodiments, an example in which the point investment server 10 is additionally added to the normal work server 20 has been explained, but the present invention is not limited thereto, and is also applicable when one server having the both functions is formed by unifying the both servers.

Of the respective processing explained in the embodiments, all or a part of the processing explained as being performed automatically may be performed manually, or all or a part of the processing explained as being performed manually may be performed automatically in a known method. The information including the processing procedure, the control procedure, specific names, and various kinds of data and parameters shown in the data or in the drawing can be optionally changed, unless otherwise specified. Similarly, contents of various input screens can be optionally changed.

The respective constituents of the illustrated apparatus are functionally conceptual, and the physically same configuration is not always necessary. In other words, the specific mode of dispersion and integration of the apparatus is not limited to the illustrated ones, and all or a part thereof may be functionally or physically dispersed or integrated in an optional unit, according to the various kinds of load and the status of use. All or an optional part of the various processing functions performed by the apparatus can be realized by the CPU or a program analyzed and executed by the CPU, or can be realized as hardware by the wired logic.

According to the present invention, it is possible to attract customers by a point service, thereby acquiring regular customers.

Moreover, according to the present invention, it is possible to execute a joint investment with ease.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An apparatus for processing a point, the point given to a customer as a reward, the apparatus comprising:
an investment executing unit that executes an investment with an amount of investment calculated based on the point of the customer; and
an investment returning unit that converts an amount of money obtained as a result of the investment into a return point, and that returns the return point to the customer.

2. The apparatus according to claim 1, wherein
the amount of investment is a total amount calculated based on the points of a plurality of the customers, and
the investment returning unit distributes and returns the return point to each of the customers.

3. The apparatus according to claim 1, further comprising an investment accepting unit that accepts, from the customer, an investment point with which the customer wishes to invest, and an investment item in which the customer wishes to invest, wherein
the amount of investment is calculated based on the investment point accepted.

4. The apparatus according to claim 3, wherein
the investment accepting unit accepts the investment point and the investment item from the customer until an execution date for the investment,
the amount of investment is calculated by accepting a plurality of investment points and a plurality of investment items from a plurality of the customers, converting the investment points into a money value for each of the investment items, and summing up the money value converted, and
the investment returning unit converts the amount of money obtained as the result of the investment for each of the investment items into the return point, and distributes and returns the return point converted to each of the customers.

5. The apparatus according to claim 4, further comprising:
a first storage unit that stores a returned point that has been returned to the customer according to the investment item, associating with the investment point and the investment item; and
a second storage unit that stores a total return point indicating a total amount of the points converted from the amount of money obtained as the result of the investment, associating with the amount of investment summed up.

6. The apparatus according to claim 3, further comprising a change accepting unit that accepts, from the customer, an instruction for a change in at least one of the investment point and the investment item, wherein
the investment executing unit executes the investment reflecting the change accepted.

7. The apparatus according to claim 6, wherein when accepting the instruction, the change accepting unit outputs, in response to a request from the customer, the investment point and the investment item stored in the first storage unit and the amount of investment stored in the second storage unit to the customer.

8. The apparatus according to claim 3, wherein the amount of investment is calculated based on a different conversion rate for each of the customers.

9. The apparatus according to claim 3, wherein the investment item includes savings, a purchase of exchange, a purchase of stocks, a purchase of a betting ticket, and a purchase of lottery.

10. The apparatus according to claim 9, wherein when the investment item is an item for which a specific investment target can be arbitrarily selected, the investment accepting unit accepts the specific investment target that is specified in advance.

11. A method for processing a point, the point given to a customer as a reward, the method comprising:
executing an investment with an amount of investment calculated based on the point of the customer;
converting an amount of money obtained as a result of the investment into a return point; and
returning the return point to the customer.

12. The method according to claim 11, wherein
the amount of investment is a total amount calculated based on the points of a plurality of the customers, and
the returning includes distributing and returning the return point to each of the customers.

13. The method according to claim 11, further comprising accepting, from the customer, an investment point with which the customer wishes to invest, and an investment item in which the customer wishes to invest, wherein
the amount of investment is calculated based on the investment point accepted.

14. The method according to claim 13, wherein
the accepting includes accepting the investment point and the investment item from the customer until an execution date for the investment,
the amount of investment is calculated by accepting a plurality of investment points and a plurality of investment items from a plurality of the customers, converting the investment points into a money value for each of the investment items, and summing up the money value converted, and
the returning includes converting the amount of money obtained as the result of the investment for each of the investment items into the return point, and distributing and returning the point converted to each of the customers.

15. A computer-readable recording medium that stores a computer program for processing a point, the point given to a customer as a reward, the computer program making a computer execute:
executing an investment with an amount of investment calculated based on the point of the customer;
converting an amount of money obtained as a result of the investment into a return point; and
returning the return point to the customer.

16. The computer-readable recording medium according to claim 15, wherein
the amount of investment is a total amount calculated based on the points of a plurality of the customers, and
the returning includes distributing and returning the return point to each of the customers.

17. The computer-readable recording medium according to claim 15, wherein
the computer program further makes the computer execute accepting, from the customer, an investment point with which the customer wishes to invest, and an investment item in which the customer wishes to invest, wherein
the amount of investment is calculated based on the investment point accepted.

18. The computer-readable recording medium according to claim 17, wherein
the accepting includes accepting the investment point and the investment item from the customer until an execution date for the investment,
the amount of investment is calculated by accepting a plurality of investment points and a plurality of investment items from a plurality of the customers, converting the investment points into a money value for each of the investment items, and summing up the money value converted, and
the returning includes converting the amount of money obtained as the result of the investment for each of the investment items into the return point, and distributing and returning the point converted to each of the customers.
